(19) United States
(12) Patent Application Publication
(10) Pub. No.: US 2013/0082949 A1
(43) Pub. Date: Apr. 4, 2013

(54) METHOD OF DIRECTLY INPUTTING A FIGURE ON AN ELECTRONIC DOCUMENT

(71) Applicants: Min-Chul KWAK, Seoul (KR); Sang-Won YOON, Gyeonggi-do (KR)

(72) Inventors: Min-Chul KWAK, Seoul (KR); Sang-Won YOON, Gyeonggi-do (KR)

(73) Assignee: INFRAWARE INC., SEOUL (KR)

(21) Appl. No.: 13/568,684

(22) Filed: Aug. 7, 2012

(30) Foreign Application Priority Data
Sep. 29, 2011 (KR) 10-2011-0099442

(51) Int. Cl. G06F 3/041

(52) U.S. Cl. 345/173

(57) ABSTRACT

The present invention relates to a technology for directly inputting figures on electronic documents, and more particularly, to a technology for directly inputting figures on electronic documents in which a rough figure which is roughly inputted using direct input means (e.g., handwriting, mouse, digitizer) is automatically converted into a regular figure object by considering preset figure templates, thereby improving figure usage and quality in electronic documents.

### BACKGROUND OF THE INVENTION

The present invention relates to a technology for directly inputting a figure on an electronic document, and more particularly, to a technology for directly inputting a figure on electronic document in which a rough figure which is roughly inputted using direct input means (e.g., handwriting, mouse, digitizer) is automatically converted into a regular figure object by considering preset figure templates, thereby improving figure usage and quality in electronic documents.

Recently, with the development of smart mobile operating systems, office programs such as PowerPoint or WordProcessor may execute on touch terminals such as smart phones or tablet terminals. Accordingly, users may frequently wishes to input figures (e.g., rectangles, triangles, flow charts) in electronic documents while using office programs. In this case, figure inputting may be performed in a similar manner as in a personal computer. That is, a user may input figures by sequentially selecting shape of figure by a menu, positioning the figure on touchscreen, and setting attribute of the figure.

Meanwhile, touch terminals may use handwriting. In general, handwriting was frequently used for drawing a figure in tablet devices. When a figure is drawn by handwritting on an electronic document, the image on the touchscreen is recognized as shown and then stored as an image file.

Prior art handwriting operation as described above may be used for inputting figures on an electronic document. In this case, however, the quality of handwritten figures are more degraded than using software menu. Worsely, the handwritten figures may have a shape other than user intention or unpreferably coarse shape.

Furthermore, a user may directly input a figure using input devices such as mouses or digitizers. In this case, the quality of the figure is generally lower than using software menu. As such, prior art electronic document softwares do not provide direct figure input mode using handwriting, mouse or digitizer operations or the like.

### SUMMARY OF THE INVENTION

An embodiment of the present invention is directed to a technology for directly inputting figures on electronic documents, in which a roughly-inputted figure is automatically converted into a regular figure object of most similar to user intention through pattern analysis, when a user directly inputs the figure on the electronic documents through handwriting, mouse or digitizer opearations.

In the present invention, a method of directly inputting a figure on an electronic document, includes the steps of: (a) receiving figure-shaped data which is directly inputted on the electronic document implemented as a UI screen; (b) evaluating similarities between the inputted figure-shaped data and a plurality of preset figure templates, and deciding a template for the figure-shaped data from the evaluation result; (c) when previously-inputted figure objects exist in a predetermined range based on an input position of the figure-shaped data on the electronic document, determining whether the figure-shaped data is a relation-type figure object or independent-type figure object; (d) when it is determined at step (c) that the figure-shaped data is a relation-type figure object and the previously-inputted figure objects are positioned in both sides of the input position of the figure-shaped data, correcting the figure-shaped data according to the template decided at step (b), and implementing the figure-shaped data by reflecting the relation with the previously-inputted figure objects existing in both sides; and (e) when it is determined at step (c) that the figure-shaped data is an independent-type figure object and the positions of the previously-inputted figure objects have a regularity, arranging the position of the figure-shaped data according to the regularity, comparing coordinate change calculated for the previously-inputted figure objects to coordinate change of the figure-shaped data, and converting the figure-shaped data into the same figure as a figure object having a maximum similarity.

### BRIEF DESCRIPTION OF THE DRAWINGS

FIG. 1 is a diagram for explaining a figure input unit for implementing a technique of directly inputting a figure on an electronic document in the present invention.

FIGS. 2 to 6 are diagrams for explaining UI screens shown on a touchscreen.

FIGS. 7 and 8 are flow charts showing a method of directly inputting a figure on an electronic document in the present invention.

### DESCRIPTION OF SPECIFIC EMBODIMENTS

Exemplary embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

In one examplary embodiment of the present invention, a user inputs a figure by handwriting on a touchscreen. However, the present invention is not limited to the embodiment, but may also be applied to a case in which a user uses other direct input means, such as mouses or digitizers.

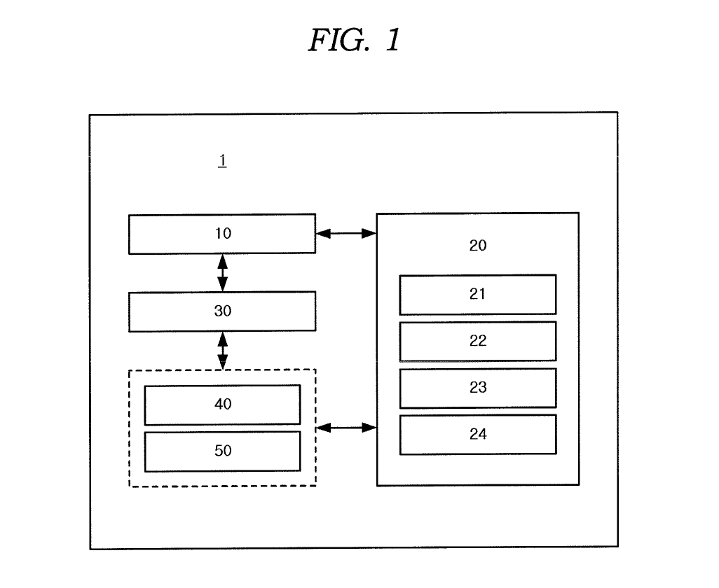

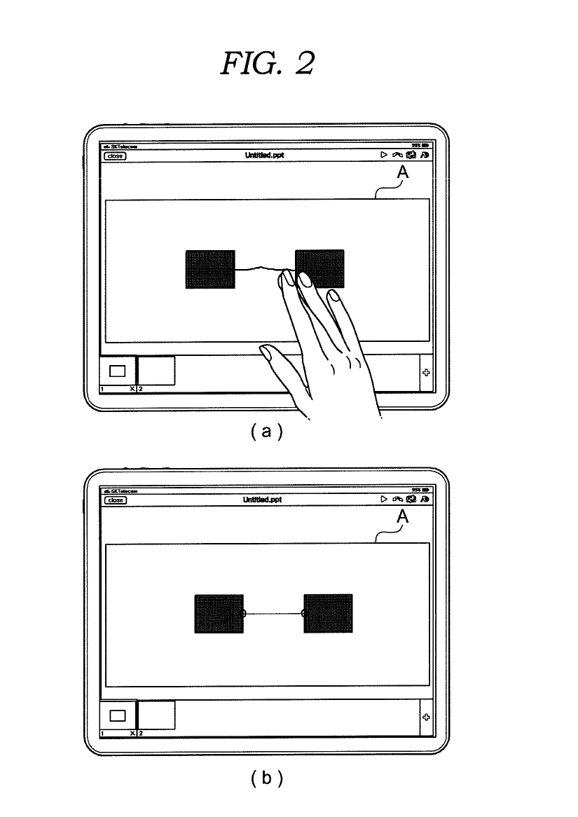

FIG. 1 is a diagram for explaining a figure input unit 20 for implementing a technique of directly inputting a figure on an electronic document in the present invention. FIGS. 2 to 6 are diagrams for explaining UI screens shown on a touchscreen 10 of FIG. 1.

Referring to FIGS. 1 to 6, a touch terminal 1 includes touchscreen 10, figure input unit 20, control unit 30, first storage unit 40, and second storage unit 50. The figure input unit 20 includes figure relation section 21, figure shape section 22, figure direction/position section 23, and candidate template section 24.

The touchscreen 10 serves to receive a touch input by a user (handwriting input). When an electronic document program stored in the second storage unit 50 is executed by the control unit 30, the touchscreen 10 forms UI touch interface for inputting a figure on an electronic document (e.g., PowerPoint).

The figure input unit 20 is described. The figure relation section 21 receives figure-shaped data which is provided by handwritting on figure input window A implemented as UI screen of the touchscreen 10. The figure relation section 21 determines whether preset figure templates exist within a predetermined range based on the handwritten figure-shaped data. The predetermined range may be 50˜100 pixels in the four directions from the handwritten position, but may differ depending on the size of the touchscreen 10. Since the user may input figures in various sizes, the predetermined range is checked after normalizing the inputted figure.

The figure relation section 21 determines whether the figure-shaped data corresponds to a preset figure template. Preferably, the figure relation section 21 first determines whether the figure-shaped data is an independent-type figure object or a figure connection object. For example, the figure relation section 21 determines whether the handwritten figure-shaped data is a linear figure and the preset figure templates within the predetermined range are positioned in both sides of the linear figure.

When the figure relation section 21 determines that the preset figure templates are positioned in both sides of the linear figure (handwriting input result), the figure shape section 22 converts the linear figure-shaped data into a straight line having no curvature, and connects the preset figure templates positioned in both sides with the converted straight line. FIGS. 2A and 2B illustrate an example of the straight line conversion and the straight line connection.

Meanwhile, when the figure relation section 21 determines that the handwritten figure-shaped data is not a linear shape or the preset figure templates are not positioned in both sides of the handwritten figure-shaped data, the figure shape section 22 determines whether two or more figure templates exist in one direction and are located at regular positions.

Then, when the figure shape section 22 determines that two or more figure templates exist and are located at regular positions, the figure direction/position section 23 identifies the regularity and then arranges the position of the handwritten figure-shaped data by the regularity.

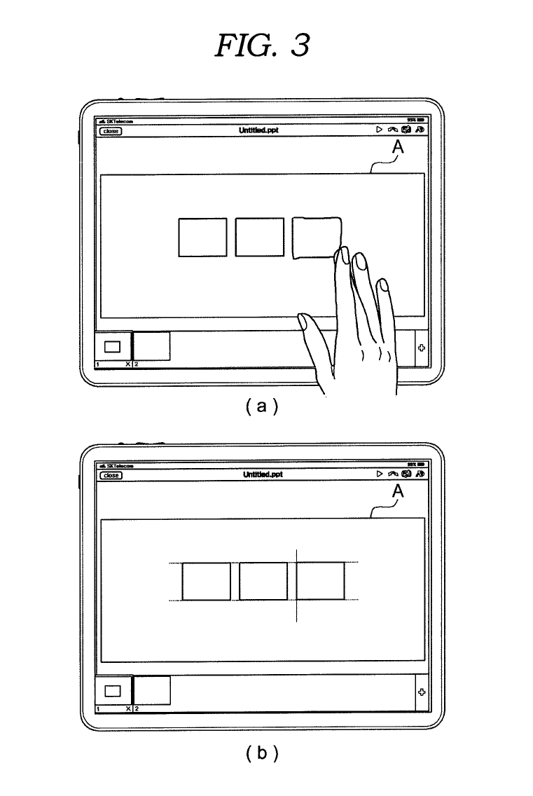

Then, the figure direction/position section 23 compares coordinate change calculated for the preset figure templates existing in one direction with coordinate change of the handwritten figure-shaped data. When the similarity therebetween is more than a threshold, the figure direction/position section 23 determines that the figure-shaped data is a figure of the preset figure template so that the handwritten figure-shaped data is converted by the preset figure template. FIGS. 3A and 3B illustrate an example of the position arrangement and the figure conversion.

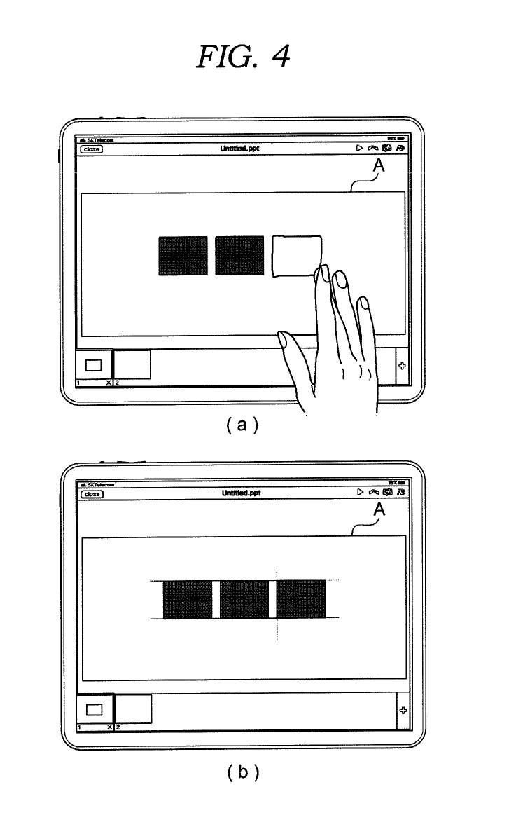

In another embodiment of the present invention, while the position arrangement for the handwritten figure and the figure conversion are performed, the internal color of the figures may be further converted as illustrated in FIGS. 4A and 4B. During the color conversion, attributes set in previously-inputted figures around the handwritten figure are reflected.

On the other hand, when the number of the preset figure templates is other than two or the preset figure templates are located at irregular positions, the figure direction/position section 23 omits position arrangement. Then, the figure direction/position section 23 compares coordinate change calculated for the one or more figures existing in one direction to the coordinate change of the handwritten figure-shaped data, and determines that the figure-shaped data may be a figure of the maximum similarity. Accordingly, the figure direction/position section 23 converts the figure-shaped data into the figure of the maximum similarity.

When the figure relation section 21 determines that preset figure templates do not exist within the predetermined range, the candidate template section 24 checks the first storage unit 40 to determine whether there exist two or more candidate figure templates whose similarity to the coordinate change of the handwritten figure is more than a threshold.

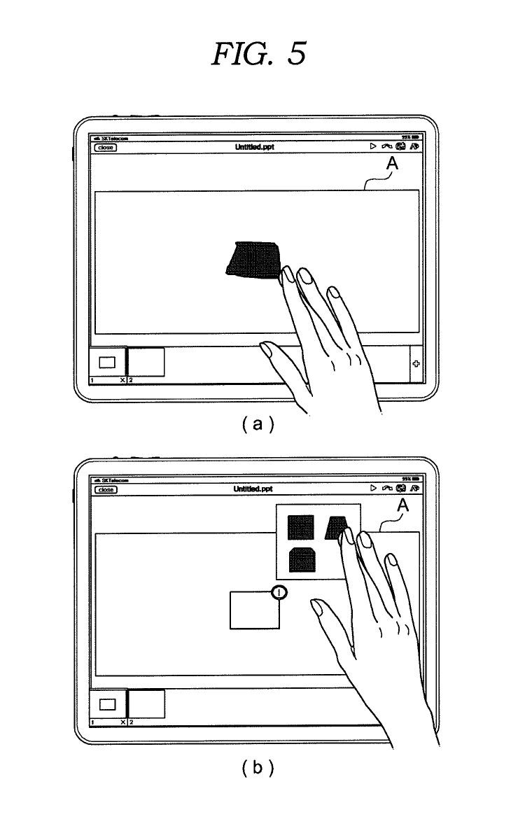

When determining that there are two or more candidate figure templates, the candidate template section 24 shows the candidate figure templates on the touchscreen 10. When one candidate figure template is selected by the user, the handwritten figure-shaped data is converted into a shape based on the selected candidate figure template (refer to FIG. 5B).

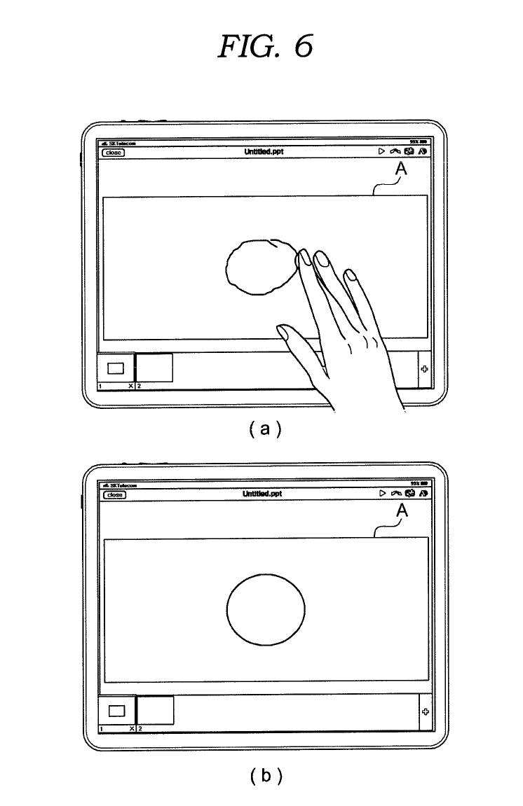

When there exists one candidate figure template whose similarity is more than the threshold, the candidate template section 24 converts the handwritten figure-shaped data into a shape based on the single candidate figure template. FIGS. 6A and 6B illustrate an example of the conversion of the figure-shaped data into the single candidate figure template.

The first storage unit 40 stores coordinate change for two or more candidate figure templates, which is compared to the coordinate change of the handwritten figure-shaped data. That is, the first storage unit 40 stores information on various figure templates which are to be compared with the handwritten figure-shaped data.

The second storage unit 50 stores the electronic document program implemented as the touchscreen 10 according to the control of the control unit 30.

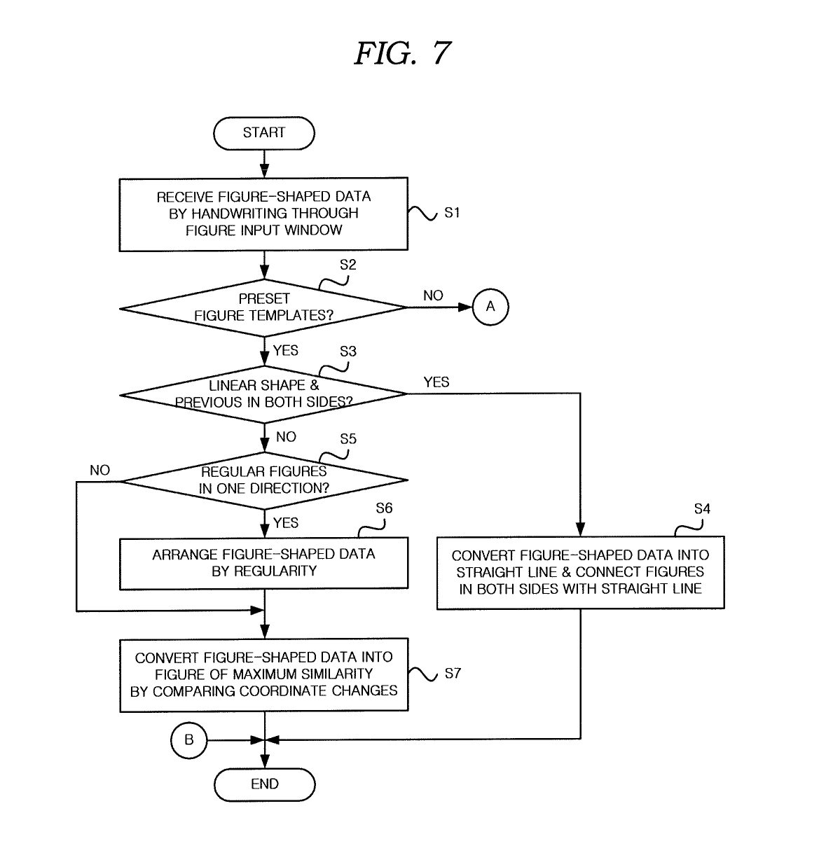

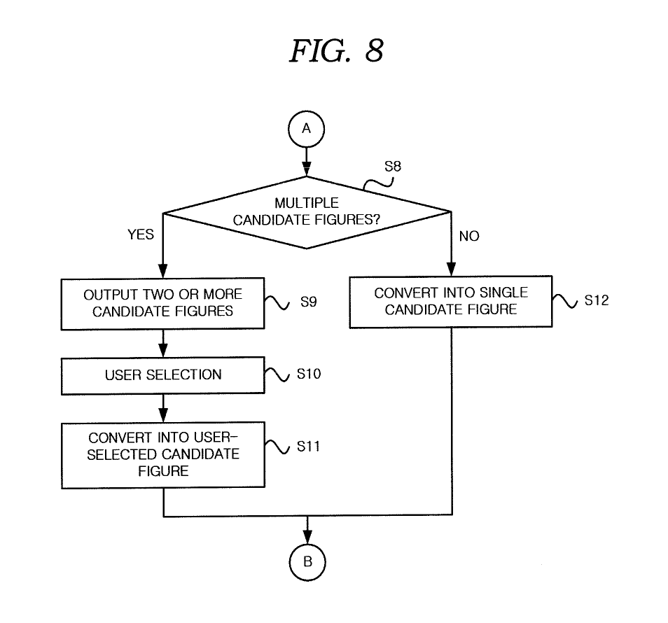

FIGS. 7 and 8 are flow charts showing a method of directly inputting a figure on an electronic document in the present invention. The method shown in FIGS. 7 and 8 has the same technical constitution as described with reference to FIGS. 1 to 6. The following descriptions will be focused on the operations of the invention. The process flow is not limited to the sequence shown in FIGS. 7 and 8, but the orders of some steps may be changed without departing from the spirit and scope of the invention.

Referring to FIGS. 1, 7, and 8, the figure input unit 20 receives figure-shaped data inputted by handwriting on the figure input window A of an electronic document implemented as an UI screen of the touchscreen 10 (S1).

The figure input unit 20 determines whether preset figure templates exist within a predetermined range from the handwritten position (S2). As described above, a user may input a figure in various sizes. Therefore, the predetermined range may be checked preferably after normalizing the inputted figure.

When it is determined at S2 that there exists a preset figure template corresponding to the figure-shaped data, the figure input unit 20 determines whether the figure-shaped data inputted at S1 is a linear figure and the preset figure templates are positioned in both sides of the linear figure (S3). That is, the figure input unit 20 determines whether the handwritten figure-shaped data is an independent-type figure object (for example, rectangle, triangle, circle, or straight line) or a relation-type figure object (for example, straight line or curve connecting two rectangles). According to the determination result, the figure input unit 20 processes the figure-shaped data.

When it is determined at S3 that the figure-shaped data is a relation-type figure object, the shape of the handwritten figure-shaped data is corrected according to the template, and the figure-shaped data is implemented from the relation with the figures positioned in both sides. For example, as illustrated in FIG. 2, when the preset figure templates are positioned in both sides of the figure-shaped data and the figure-shaped data is a linear shape, the figure input unit 20 converts the figure-shaped data into a straight line having no curvature, and connects the figures positioned in both sides of the figure-shaped data through the straight line (S4).

Meanwhile, when it is determined at S3 that the figure-shaped data inputted at S1 is an independent-type figure object, the figure input unit 20 checks the relation between the figure-shaped data and previously-inputted figures around the figure-shaped data. For example, the figure input unit 20 determines whether there exist two or more preset figure templates in one direction and the preset figure templates are located at regular positions (S5).

When it is determined at S5 that there are two or more previously-inputted figure templates around the figure-shaped data and the figure templates are located at regular positions, the figure input unit 20 extracts the regularity of the attribute (for example, position arrangement) existing between the previously-inputted figures, and arranges the position of the figure-shaped data inputted at S1 according to the extracted regularity, as illustrated in FIGS. 3A and 3B (S6).

Then, the figure input unit 20 compares coordinate change calculated for the preset figure templates existing in one direction to coordinate change of the figure-shaped data inputted at S1, determines that a preset figure template of the maximum similarity is the same figure as the figure-shaped data inputted at S1, and converts the figure-shaped data (S7).

Meanwhile, when it is determined at S7 that the number of preset figure templates around the inputted figure-shaped data is other than two or more or the figure templates are located at irregular positions even though the number is two or more, the position arrangement of the figure-shaped data at S6 is omitted, and the figure input unit 20 compares coordinate change calculated for one or more figures existing in one direction to the coordinate change of the figure-shaped data inputted at S1, and determines that the figure-shaped data is a figure of the maximum similarity. Accordingly, the figure input unit 20 converts the figure-shaped data into the figure of the maximum similarity at S7.

Returning to S2, when it is determined that preset figure templates do not exist in the predetermined range, the figure input unit 20 checks the first storage unit 40 to determine whether there exist two or more candidate figure templates whose similarity to the coordinate change of the figure-shaped data inputted at S1 is more than a threshold (S8).

When it is determined at S8 that there exist two or more candidate figure templates whose similarity is more than the threshold, the figure input unit 20 outputs two or more candidate figure templates onto the UI screen as illustrated in FIG. 5B (S9). When one candidate template among the candidate figure templates is selected by the user at S10, the figure input unit 20 converts the figure-shaped data inputted at S1 into a shape based on the selected candidate figure template at S11.

Meanwhile, when it is determined at S9 that there exists one candidate figure template whose similarity is more than the threshold, the figure input unit 20 converts the figure-shaped data inputted at S1 into a shape based on the single candidate figure template (S12).

According to the embodiments of the present invention, the method automatically converts a rough figure of direct input means into a regular figure object by considering preset figure templates, thereby improving figure usage and quality in an electronic document. That is, it is possible to input a figure more efficiently and correctly than when an electronic document is written on various user terminals. Furthermore, when a figure inputted by the direct input means is automatically converted into a regular figure object, the shapes and positions of figures around the inputted figure may be recognized, and the shape and position of the inputted figure may be set to maintain consistency with the surroundings, which makes it possible to make the electronic document operation convenient.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

1. A method of directly inputting a figure on an electronic document, comprising the steps of:
(a) receiving figure-shaped data which is directly inputted on the electronic document implemented as a UI screen;
(b) evaluating similarities between the inputted figure-shaped data and a plurality of preset figure templates, and deciding a template for the figure-shaped data from the evaluation result;
(c) when previously-inputted figure objects exist in a predetermined range based on an input position of the figure-shaped data on the electronic document, determining whether the figure-shaped data is a relation-type figure object or independent-type figure object;
(d) when it is determined at step (c) that the figure-shaped data is a relation-type figure object and the previously-inputted figure objects are positioned in both sides of the input position of the figure-shaped data, correcting the figure-shaped data according to the template decided at step (b), and implementing the figure-shaped data by reflecting the relation with the previously-inputted figure objects existing in both sides; and
(e) when it is determined at step (c) that the figure-shaped data is an independent-type figure object and the positions of the previously-inputted figure objects have a regularity, arranging the position of the figure-shaped data according to the regularity, comparing coordinate change calculated for the previously-inputted figure objects to coordinate change of the figure-shaped data, and converting the figure-shaped data into the same figure as a figure object having a maximum similarity.

2. The method according to claim 1, further comprising the step of, (f) when it is determined at step (c) that the figure-shaped data is an independent-type figure object and the previously-inputted figure objects are not located at regular positions, comparing the coordinate change calculated for the previously-inputted figure objects to the coordinate change of the figure-shaped data, and converting the figure-shaped data into the same figure as a figure object of the maximum similarity.

3. The method according to claim 1, wherein the direct input comprises a touch operation.

4. A computer-readable recording medium storing a program for directly inputting a figure on an electronic document, comprising:
a figure relation determination unit configured to receive figure-shaped data which is directly inputted on the electronic document implemented as a UI screen, and determine whether the figure-shaped data is a relation-type figure object or independent-type figure object, when previously-inputted figure objects exist within a predetermined range based on an input position of the figure-shaped data on the electronic document;
a candidate figure template determination/selection unit configured to evaluate similarities between the figure-shaped data and preset figure templates, and decide a template for the figure-shaped data from the evaluation result;
a figure shape determination unit configured to correct the figure-shaped data according to the template decided by the candidate figure template determination/selection unit, when the figure relation determination unit determines that the figure-shaped data is a relation-type figure object and the previously-inputted figure objects are positioned in both sides of the input position of the figure-shaped data, and implement the figure-shaped data by reflecting the relation with the previously-inputted figure objects existing in both sides; and
a figure direction/position determination unit configured to arrange the position of the figure-shaped data according to a regularity, when figure-shaped data is an independent-type figure object and the positions of the previously-inputted figure objects have the regularity.

5. The computer-readable recording medium according to claim 4, wherein the figure direction/position determination unit compares coordinate change calculated for the previously-inputted figure objects to coordinate change of the figure-shaped data, and converts the figure-shaped data into the same figure as a figure object of the maximum similarity.

6. The computer-readable recording medium according to claim 5, wherein, when the figure relation determination unit determines that the figure-shaped data is an independent-type figure object and the previously-inputted figure objects are not located at regular positions, the figure direction/position determination unit compares the coordinate change calculated for the previously-inputted figure objects to the coordinate change of the figure-shaped data, and converts the figure-shaped data into the same figure as a figure object of the maximum similarity.

7. The method according to claim 2, wherein the direct input comprises a touch operation.
